(19) United States
(12) Patent Application Publication
(10) Pub. No.: US 2006/0136426 A1
(43) Pub. Date: Jun. 22, 2006

(54) Method for automated control of an internet site, as well as a use

(75) Inventor: Mathias Roth, Walldorf (DE)

Correspondence Address: GANZ LAW, P.C., P O BOX 2200, HILLSBORO, OR, 97123, US

(73) Assignee: iOpus Software GmbH, Walldorf (DE)

(21) Appl. No.: 11/313,487

(22) Filed: Dec. 20, 2005

(30) Foreign Application Priority Data
Dec. 22, 2004 (DE) 102004062909.9-53

(51) Int. Cl. G06F 17/30

(52) U.S. Cl. 707/10

(57) ABSTRACT

The invention relates to a method for automated control of an Internet site, and to a use of the method for automation of repetitive control sequences for Internet accesses. According to the invention, a predeterminable image is searched at any desired position on the Internet site (IS) with the aid of an image recognition method, and a positive search result is output and a predeterminable message is sent to the input window (EF) if the predeterminable image is found on the Internet site (IS), or a negative search result is output if the predeterminable image is not found on the Internet site (IS). Use, for example, for automated testing of the operation of Internet sites.

### CROSS REFERENCE TO RELATED APPLICATION

This application claims priority to German Patent Application No. 10 2004 062 909.9 filed on Dec. 22, 2004 in the German Patent and Trademark Office (DPMA), the entire contents of which are herby incorporated by reference.

### BACKGROUND FOR THE INVENTION

The invention relates to a method for automated control of an Internet site, and to a use of the method for automation of repetitive control sequences for Internet accesses.

So-called macros, for example, are used to automate repetitive control procedures for software programs. In this case, a so-called macro recorder normally records a sequence of inputs by a user, and these are played back as required, for example initiated by a single control command. Macro recorders and macro functionalities such as these are normally already integrated in conventional word processing programs, table calculation programs or databank programs.

Software programs, for example a product from the applicant with the product name Internet-Makros, likewise exist for automation of Internet accesses, in which a user uses a so-called Internet browser to enter an Internet address, and then uses the browser to input data to the Internet site or the web site or sites which has or have been loaded. These programs record the user inputs, and repeat them as required.

This makes it possible, for example, to permanently monitor the correct operation of a so-called on-line shop via which goods can be ordered and purchased via the Internet. For this purpose, a control sequence which is associated with an order process is entered, for example at fixed time intervals, on the associated Internet site, and the program monitors whether the reaction by the Internet site corresponds with the reaction to be expected. If this is not the case, that is to say if an error occurs, the program can generate an automatic message, for example an e-mail, to the operator of the on-line shop. Further application examples are the automated filling-out of forms, automated system registration or the loading of files.

When recording operator inputs, the program stores specific sequences or elements, which are associated with an input, in the Hypertext Markup Language (HTML) code for the loaded Internet site. On reproduction, these elements or this element are or is looked for on the loaded Internet site. When it is found, a specific action is initiated for this element, for example a mouse click and/or a text input. In order to check whether an input leads to an expected reaction, that is to say whether the input has been made, the program or the software can then search for the text elements or character sequences to be expected on the Internet site following an appropriate input, with the search being carried out on the basis of a character string comparison. In the case of an Internet site of an on-line shop, this may, for example, be the character sequence or the text “order placed”. However, methods such as these function only on pure HTML sites.

Nowadays, however, Internet sites frequently contain elements which are not based on HTML, for example so-called Java and/or FLASH Applets, or are composed entirely of them. These elements or controls are likewise displayed on the Internet site, but in contrast to pure HTML elements, are essentially autonomous programs which run in the context of the browser and allow or carry out user interactions, that is to say inputs and/or outputs, without there being any specific sequences or elements associated with an input or output, as in the case of HTML, in the code of the Internet site, and without any such sequences and elements being generated. In other words, there is normally now access to the “intrinsic operation” of these elements so that it is not possible to carry out the method of storage and relocation of a control element, as it functions for pure HTML sites in this case.

In order nevertheless to allow automation, the X/Y coordinates of an input operation, for example a mouse click or a text input, can be recorded during the recording of the operator inputs, and the input previously made by the user can be repeated at the same coordinates when the recorded input operation is reproduced, that is to say, for example, a so-called mouse click message can be sent to those coordinates. However, since there is generally no direct access to the state or to the parameters of the control, the result of inputs made in this way cannot be checked. For example, when an access is made in an automated manner such as this to the Internet site of an on-line shop, it is not possible to check after executing an order command whether the expected message, for example the order, has or has not actually also been issued.

A further problem with the permanent storage of coordinates occurs when the input window does not have a fixed position on the Internet site, but is arranged dynamically on the Internet site, that is to say as a function of other screen contents which, for example, either did not yet exist or were in a different form at the time of recording. Input windows that have been shifted in this way are no longer “hit” by the message that is sent to the old coordinates, so that the desired control sequence is interrupted, and it is no longer possible to ensure an error-free procedure. This can lead to an error even though the Internet site or sites being used are operating correctly.

U.S. Pat. No. 5,511,185 discloses a method for automated testing of computer software, in which user inputs which have been made via an interface unit, and the associated screen outputs, are stored. In order to test the software, the stored inputs are repeated exactly in an automated form, and the actual screen outputs are compared with the stored screen outputs.

### SUMMARY OF THE INVENTION

The technical problem on which the invention is based is to provide a method for automated control of an Internet site, which allows evaluation of contents of the Internet site reliably even when this site has elements which go beyond purely HTML-based elements, for example FLASH and/or Java Applets.

According to a first embodiment, the method comprises the searching of a predeterminable image which contains an input window at any desired position on a display of an Internet site with the aid of an image recognition method, and the outputting of a positive search result and the sending of a predeterminable message to the input window when the predeterminable image corresponds to an image that is being found on the Internet site, within a predeterminable matching scale of the image recognition method, or the outputting of a negative search result when the predeterminable image is not found on the Internet site.

The input window may in this case, for example, be a text input window, a menu structure, a sliding element, a key (or a button which can be operated) or a sensitive area which reacts when the mouse is moved over it. In total, this covers all of the graphics input options which are available with normal operating systems and which react to inputs and/or messages. Messages are in this case system instructions which are defined by the operating system and are produced by the operating system, stimulated by user inputs. By way of example, a message may represent the pushing of a button, or a text input.

The method allows evaluation of the contents of the Internet site, in which only the predeterminable image to be searched needs to be known, and whose position may be undefined on the Internet site. This makes it possible, for example, to check whether an input which has already been made, or action on the Internet site, has led to the desired reaction, when it is known which image element (which may also be a character string displayed graphically or in the form of an image) must appear as a reaction to the input. The search and the comparison are in this case not carried out as in the conventional manner by the comparison of character strings which, for example, may not be possible to extract from the code of the Internet site when using Java Applets, but is carried out on the basis of an image comparison. The predeterminable matching measure allows reliable evaluation even when the image to be searched has changed slightly, dynamically. Discrepancies and changes to be ignored may, for example, be changes to a font type and/or a change to the print size of a text within the image to be searched.

In a development of the method, a positive search result is output if the predeterminable image and an image of the Internet site differ only in the colors. This may be a change to the background color and/or a change to a foreground color, for example a script color.

In a development of the method, in addition to outputting a positive search result, one coordinate of the image is determined, which represents the position of the image on the Internet site. The position is in this case typically the X/Y coordinates relative to a reference point. This makes it possible, for example, to locate a known image on the Internet site when its position or its coordinates has or have changed between successive accesses to the Internet site. By way of example, the coordinates may be used to send a message to this position. Overall, this allows the automation of control sequences during which a user makes an input in an input window, whose position may change between successive accesses to that Internet site. Instead of storing the coordinates of a user input, for example of a mouse click, in the normal manner, the image of the associated input window is stored. On reproduction, the coordinates which are associated with that image, for example that input window, are then searched for and, if the image is found, the message, which has likewise been stored, is sent to these coordinates.

In a development of the method, the image contains an output window of the Internet site. An output window should in this case be regarded in general as a reaction, that is to say an image or graphics change, from the Internet site to an input. By way of example, this may be a text window in which an entered text is displayed, or a fold-up menu structure. The method advantageously comprises searching an output window whose form is governed by the transmitted message, and output an error if the form of the output window does not correspond to the form to be expected. In this case, a graphics check is in consequence carried out to determine whether the Internet site is reacting in the expected manner to an input, that is to say whether, for example, a so-called mouse-over effect, stimulated by moving over the associated input window or input area, has occurred or whether a text that has been entered has also actually been emitted.

According to a second embodiment the method for automation of repetitive control sequences during Internet accesses is used in particular for Internet accesses to Internet sites. The method is advantageously used for automated functional testing of Internet sites, for filling out forms that are provided on Internet sites, for automatic system registration, for data extraction from Internet sites, and/or for file transfer from and to Internet sites. The use of the method also allows the automation of Internet accesses even when an access is made to Internet sites which are not pure HTML sites, but also additionally have elements to which no conventional access is possible.

### BRIEF DESCRIPTION OF THE DRAWINGS

Advantageous embodiments of the invention will be described in the following text and are illustrated in the drawings in which, schematically:

FIG. 1 shows an Internet site to be analyzed,

FIG. 2 shows a first image to be searched on the Internet site shown in FIG. 1,

FIG. 3 shows a second image to be searched on the Internet site shown in FIG. 1,

FIG. 4 shows a source text with pseudocode of a macro, by means of which a control sequence for the Internet site shown in FIG. 1 is automated, and

FIG. 5 shows the graphics display of the text “Hello World”.

### DETAILLED DESCRIPTION OF THE DRAWINGS

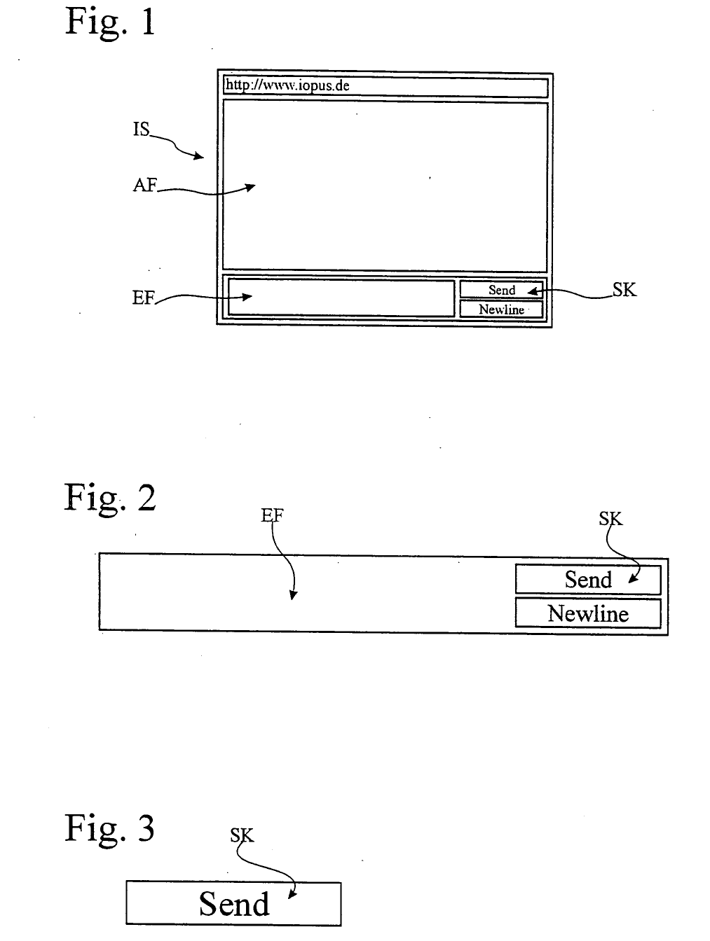

FIG. 1 shows an Internet site IS which is intended to be analyzed and can be called up at an Internet address that is not identified in any more detail, directly after it has been called up in an undefined Internet Browser, for example Microsoft Internet Explorer. It is also, of course, possible to call up the Internet site IS only in an Intranet, in which case no distinction is drawn between the Internet and an Intranet for the purposes of the application. It is also possible for the Internet sites to be tested and a program carrying out the analysis process to be located on the same computer. This is the situation, for example, during the development of an Internet site or an Internet application, in which the Internet site is created in file form on the computer and its appearance and behavior are then tested by calling up the file in a browser in the computer. The method according to the invention can in addition also be applied to merely local programs which have a browser-based user interface.

The illustrated Internet site IS is a site based on FLASH technology, which provides a so-called chat application allowing messages to be interchanged between different registered users.

FIG. 2 shows a first image which is to be searched on the Internet site in FIG. 1 and represents a text input window EF. Any desired texts which can be sent to the other subscribers in the chat application can be entered in the text input window EF.

A send button SK, which is shown in FIG. 3 and represents a second image on the Internet site IS, must be operated by a mouse click in order to send the entered text.

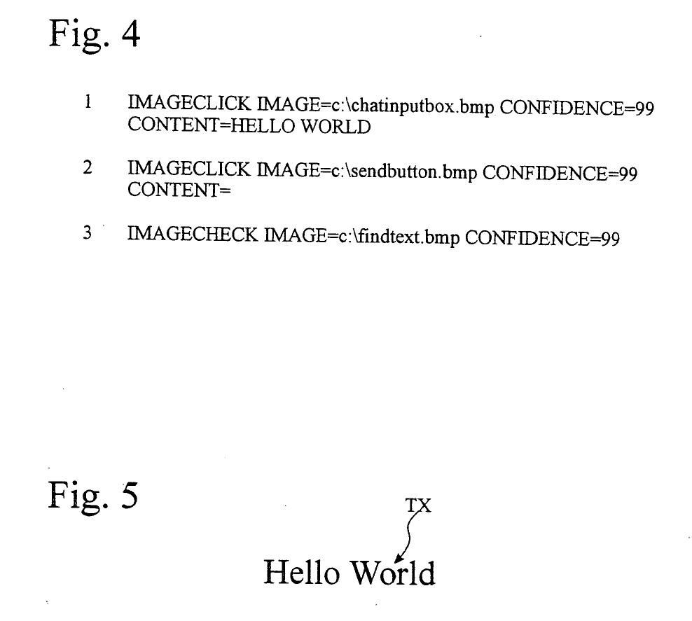

FIG. 4 shows a source text with pseudocode of a macro, by means of which one possible control sequence for the Internet site IS shown in FIG. 1 is automated, and the control sequence can be used to monitor the operation of the Internet site IS. The illustrated macro is executed by an associated interpreter, which converts the functions called up to appropriate system instructions.

In a first line, a function IMAGECLICK with a parameter IMAGE to which the value “c:\chatinputbox.bmp” is assigned, a parameter CONFIDENCE to which the value 99 is assigned, and a parameter CONTENT to which the value “Hello World” is assigned are called out. The function IMAGECLICK searches in a first step for the image IMAGE, which is in this case represented by the file c:\chatinputbox.bmp. The image to be searched is the input window EF illustrated in FIG. 2.

The parameter CONFIDENCE governs the required level of match between the image on the Internet site and the image to be searched for a positive search result to be output. A decrease in value allows greater discrepancies between the predeterminable image and the image on the Internet site. If the parameter value is 100, this requires a complete match, that is to say a binary match, between the images. Tolerable discrepancies which are taken into account by the CONFIDENCE parameter are, for example, changes in the font type, changes in the script size of a text within the image to be searched, a change to the background color and/or a change to a foreground color, for example a script color. The value 99 indicates that there may be only minor differences between the images.

The method used for searching in the simplest case carries out only a point or pixel-by-pixel comparison between the images. However, more complex image and pattern recognition methods can be used which allow more powerful searching, particularly in the event of greater discrepancies between the images.

If the image is not found on the Internet site IS, the function IMAGECLICK returns an error value, which can be dealt with by an error routine (which is not shown) in the macro. If the image is found, as in the illustrated situation, the coordinates of the image that has been found are first of all determined on the Internet site, and a message, that is to say a system instruction whose content is defined by the parameter CONTENT is then sent to the determined coordinates. In this case, the character string “Hello World” is transmitted as the content. The centerpoint of the image found is used for coordinate definition.

Line 1 in FIG. 4 in consequence simulates a user who is searching the input window EF on the Internet site IS and, once he has found it, enters the text “Hello World” in the input window EF.

The text is intended to be sent once it has been entered. To do this, the send button SK, which is shown in FIG. 3 and represents the second image to be searched on the Internet site, must be operated by a mouse click. For this purpose, the function IMAGECLICK is provided once again in a second line of the macro, as can be seen in FIG. 4. The parameter IMAGE now has the value “c:\sendbutton.bmp”. This file represents the send button SK shown in FIG. 3. The CONFIDENCE parameter has the value 99, as in line 1. Once the send button SK has been found, its coordinates are determined and a message is then sent to these coordinates, corresponding to a mouse click. The message does not have any additional text content.

If the Internet site IS is operating correctly, the entered text content must be visible in an output window AF of the Internet site, in which the transmitted text is normally displayed, after a certain delay time. It is now, therefore, necessary to search the output window AF or the image detail on the Internet site whose form and image representation are defined by the transmitted message, in this case the text “Hello World”.

For this purpose, a function IMAGECHECK with the parameter IMAGE to which the value “c:\findtext.bmp” is assigned, and with the parameter CONFIDENCE to which the value 99 is assigned, are called up in a third line of the macro. The function IMAGECHECK searches for the image IMAGE, which is represented in this case by the file c:\findtext.bmp. The image findtext.bmp to be searched is the image or graphic representation of the text “Hello World” and is illustrated in FIG. 5, by way of example, for a script type as the image TX. While the image TX which embodies the text has been found, the function returns a success message, otherwise it returns an error message.

The images and/or image files chatinputbox.bmp, sendbutton.bmp and findtext.bmp to be searched and which each represent an image detail or site detail of the loaded Internet site, can be specified and stored during a recording phase of the control sequence by the program or by the user. Retrospective creation, processing and/or storage of the image files are/is also possible.

The described exemplary embodiments make it clear that the invention allows automation of repetitive control sequences on Internet sites which contain elements to which direct access may not exist, with the capability to check the behavior to be expected of the Internet sites.

1. A method for automated control of Internet sites (IS) having the following steps:
search a predeterminable image (EF, SK, TX) at any desired position on a display of an Internet site (IS) with the aid of an image recognition method, with the image containing an input window (EF) for the Internet site (IS), and
output a positive search result and send a predeterminable message to the input window (EF) if the predeterminable image (EF, SK, TX) corresponds to an image found on the Internet site (IS) within a predeterminable matching scale of the image recognition method, or output a negative search result if the predeterminable image (EF, SK, TX) is not found on the Internet site (IS).

2. The method as claimed in claim 1, wherein a positive search result is output if the predeterminable image (EF, SK, TX) and an image of the Internet site differ only in the colors.

3. The method as claimed in claim 1, wherein, in addition to outputting a positive search result, a coordinate of the image is determined, which represents the position of the image on the Internet site.

4. The method as claimed in claim 1, wherein the image contains an output window (AF) of the Internet site (IS).

5. The method as claimed in claim 4, comprising the following steps:
search an output window (AF) whose form is governed by the transmitted message, and
output an error if the form of the output window (AF) does not correspond to the form to be expected.

6. Use of the method as claimed in claim 1 for automation of repetitive control sequences for Internet accesses, in particular to Internet sites.

7. Use as claimed in claim 6 for automated functional testing of Internet sites, filling out forms which are provided on Internet sites, for automatic system registration, for data extraction from Internet sites and/or for file transfer from and to Internet sites.
